(19) United States
(12) Patent Application Publication
(10) Pub. No.: US 2018/0088555 A1
(43) Pub. Date: Mar. 29, 2018

(54) MANAGEMENT SYSTEM AND MANAGEMENT METHOD

(71) Applicant: Panasonic Intellectual Property Management Co., Ltd., Osaka (JP)

(72) Inventor: ATSUTO SHIMADA, Tokyo (JP)

(21) Appl. No.: 15/644,275

(22) Filed: Jul. 7, 2017

(30) Foreign Application Priority Data
Sep. 28, 2016 (JP) 2016-189651

(51) Int. Cl. G05B 19/408

(52) U.S. Cl. CPC G05B 19/408; G05B 2219/31034

(57) ABSTRACT

A management system (component mounting system) which manages component information from an identification code which is attached to a component reel which houses electronic components (components) includes a recognizer (batch recognition reader, code reader) which scans the identification code and recognizes a code which is recorded in the identification code, information decoders which decode at least any one of item name information, order information, serial number, number of components, and vendor information from the recognized code, and a storage unit (recognition storage unit, terminal storage unit, and main storage unit) which stores each item of decoded information. In a case in which each item of information is divided into a plurality of identification codes and recorded on the component reel, each item of the information which is decoded from all of the identification codes is associated with the identification code thereof and stored in the storage unit.

### BACKGROUND

### 1. Technical Field

The present invention relates to a management system and a management method for managing a component reel which houses electronic components.

### 2. Description of the Related Art

An electronic component which is mounted onto a board in a component mounter is supplied by a component reel that winds and stores a carrier tape that houses electronic components. On the side surface of the component reel, an identification code including information relating to the electronic component to be housed is affixed. In the factory, a worker recognizes the identification code which is affixed to the component reel to manage the electronic component (refer to PTL 1, for example). PTL 1 describes a method of newly generating an individual label having an individual ID associated with an identification code, attaching the individual label to a component reel, and managing the component reel using the individual ID when the component reel is delivered to the factory.

### CITATION LIST

### Patent Literature

PTL 1: Japanese Patent Unexamined Publication No. 2005-515559

### SUMMARY

A management system of the disclosure which manages component information from an identification code which is attached to a component reel which houses electronic components includes a recognizer which scans the identification code which is attached to the component reel and recognizes a code which is recorded in the identification code, an information decoder that decodes at least any one of item name information, order information, serial number, number of components, and vendor information from the code which is recognized, and a storage unit which stores each item of the information which is decoded, in which in a case in which each item of the information is divided into a plurality of identification codes and recorded on the component reel, when the information of the component reel is registered, each item of the information which is decoded from all of the identification codes is associated with the identification code thereof and stored in the storage unit.

A management method of the disclosure which manages component information from an identification code which is attached to a component reel which houses electronic components includes recognizing in which the identification code which is attached to the component reel is scanned and a code which is recorded in the identification code is recognized, information decoding in which at least any one of item name information, order information, serial number, number of components, and vendor information is decoded from the code which is recognized, and storing in which each item of the information which is decoded is stored, in which in a case in which each item of the information is divided into a plurality of identification codes and recorded on the component reel, and when the information of the component reel is registered, each item of the information which is decoded from all of the identification codes is associated with the identification code thereof and stored in the storing.

According to the disclosure, it is possible to manage a component reel in a delivered state.

### BRIEF DESCRIPTION OF THE DRAWINGS

FIG. 1 is a configuration explanatory diagram of a component mounting system of an exemplary embodiment of the invention;

FIG. 2 is a configuration explanatory diagram of a component reel which is used in the component mounting system of an exemplary embodiment of the invention;

FIG. 3 is a configuration explanatory diagram of a component housing device with which the component mounting system of an exemplary embodiment of the invention is provided;

FIG. 4 is a plan view of a component mounter with which the component mounting system of an exemplary embodiment of the invention is provided.

FIG. 5A is a configuration explanatory diagram of a component supplier of a component mounter with which the component mounting system of an exemplary embodiment of the invention is provided;

FIG. 5B is a configuration explanatory diagram of a tape feeder with which the component mounting system of an exemplary embodiment of the invention is provided;

FIG. 6 is a block diagram illustrating the configuration of a control system of the component mounting system of an exemplary embodiment of the invention;

FIG. 7 is a block diagram illustrating the configuration of a control system of a portable terminal which is used in the component mounting system of an exemplary embodiment of the invention;

FIG. 8 is a configuration explanatory diagram of an identification code which is attached to a component reel which is used in the component mounting system of an exemplary embodiment of the invention;

FIG. 9 is a flowchart of a first example of a management method of an exemplary embodiment of the invention;

FIG. 10 is a flowchart of a second example of a management method of an exemplary embodiment of the invention; and

FIG. 11 is a flowchart of a third example of a management method of an exemplary embodiment of the invention.

### DETAILED DESCRIPTION

Before an exemplary embodiment of the disclosure is described, a problem in the related art is briefly described. In the related art including PTL 1, it may not be possible to manage a component reel within a factory unless an individual label which is provided with an individual ID is attached to the component reel, and there is a problem in that work of producing and attaching a label which is provided with an individual ID arises.

Therefore, an object of the disclosure is to provide a management system and a management method capable of managing component reels in a delivered state.

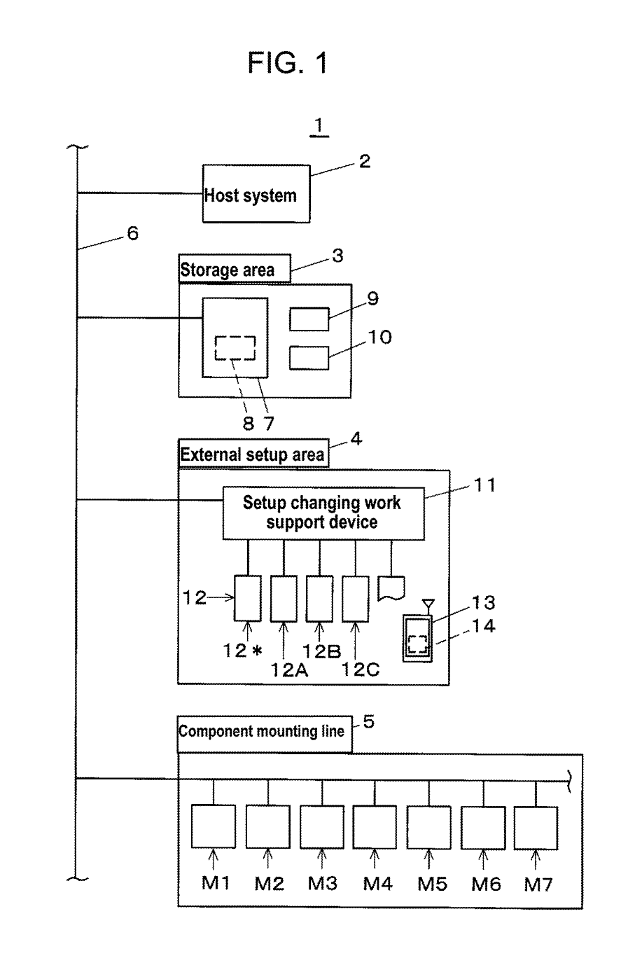

The exemplary embodiment of the invention will be described with reference to the drawings. First, description will be given of the configuration of component mounting system 1 with reference to FIG. 1. Component mounting system 1 has a function of managing electronic components (hereinafter simply referred to as “components”) to be mounted onto a board, and mounting components onto the board to produce a mounted board. Component mounting system 1 is mainly formed of host system 2, storage area 3, external setup area 4, and component mounting line 5, and these components are connected by network 6. Host system 2 is provided with a management computer, and manages production data and component information which are used in component mounting system 1.

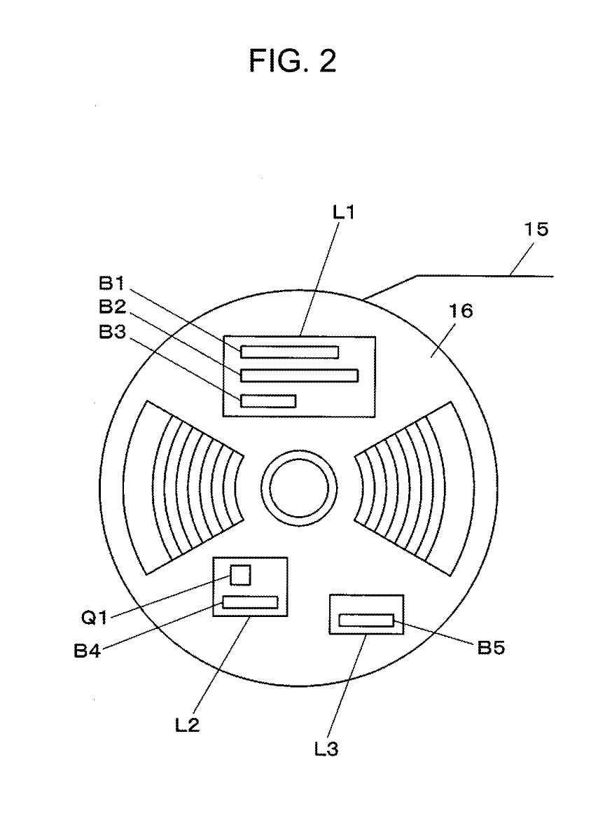

In addition to component storage device 7 which is connected to network 6, remaining number measuring device 9 and label printer 10 are installed in storage area 3. Component storage device 7 stores component reel 16 (refer to FIG. 2) which winds and houses carrier tape 15 that stores the components to be mounted onto a board. New component reel 16 which is in a state of being delivered from a vendor, in-use component reel 16 in which a portion of the components are used in the production of a mounted board in component mounting line 5, and the like are stored in component storage device 7.

Remaining number measuring device 9 measures the remaining number (number of components N) of the components of in-use component reel 16 in which a portion of the components are used in the production of the mounted board. Label printer 10 prints identification code D, such as a one-dimensional code or a two-dimensional code for recording number of components N which are housed in component reel 16, onto label L (refer to FIG. 2) to be attached to component reel 16. In addition, component storage device 7 is provided with batch recognition reader 8 which includes a camera, a laser scanner, or the like and recognizes, as a batch, the identification codes D of the plurality of labels L which are attached to component reel 16.

Here, the configuration of component reel 16 will be described with reference to FIG. 2. Carrier tape 15 is wound and housed in component reel 16. A plurality of labels L (label L1, label L2, and label L3) are attached to the side surface of component reel 16. An identification code D including a code C which represents various information is printed on each label L by a vendor that manufactures carrier tape 15 or component reel 16 on which carrier tape 15 is wound and housed, or by a worker who is responsible for delivering the components.

In FIG. 2, bar-codes B1, B2, and B3 which are one-dimensional codes are printed on label L1, two-dimensional code Q1 and bar-code B4 are printed on label L2, and bar-code B5 is printed on label L3. As described above, label L on which identification code D such as bar-code B or two-dimensional code Q is printed is attached to component reel 16 which houses the components (the electronic component). Number of components N is printed on label L3 as bar-code B5 by label printer 10.

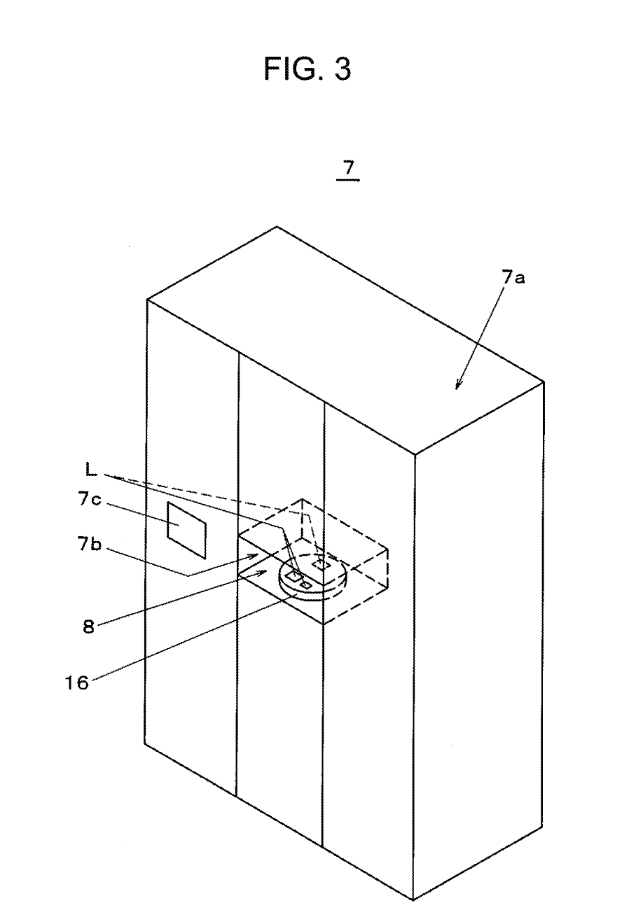

Here, the configuration of component storage device 7 will be described with reference to FIG. 3. Component storage device 7 is provided with batch recognition reader 8 and automatic housing unit 7a. When component reel 16 is inserted from inlet-outlet 7b which is provided on the front surface of component storage device 7, a plurality of identification codes D which are printed on the plurality of labels L which are attached to component reel 16 are scanned by batch recognition reader 8, as a batch, and code C which is recorded in identification code D is recognized. In other words, batch recognition reader 8 is a recognizer which scans identification code D which is attached to component reel 16 and recognizes code C which is recorded in identification code D.

Automatic housing unit 7a transports and stores component reel 16 for which code C is recognized to a predetermined position of automatic housing unit 7a. Automatic housing unit 7a carries out component reel 16 which is specified by the worker using host system 2 or touch panel 7c of the component storage device to inlet-outlet 7b.

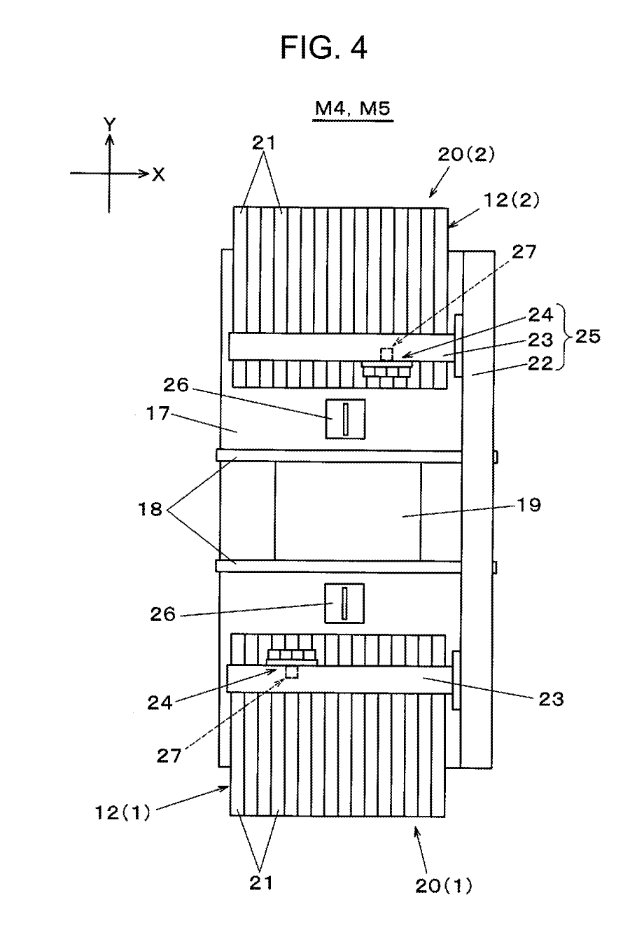

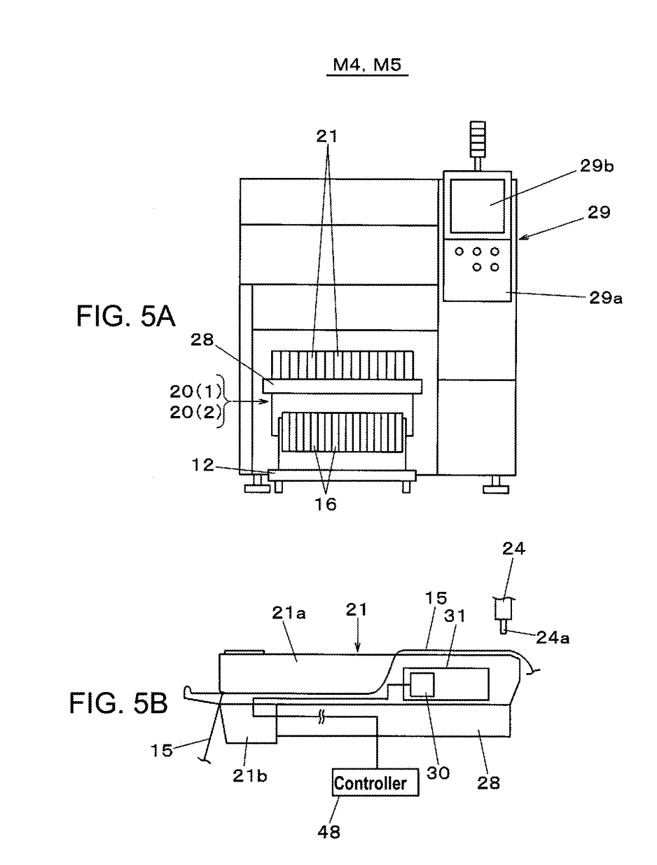

In FIG. 1, external setup area 4 is provided with setup changing work support device 11 for supporting external setup changing work. Setup changing work support device 11 is a terminal device which is provided with a calculation processing function, an input-output operation function, and a display function, such as a personal computer. According to the work instruction information which is displayed on the display screen of setup changing work support device 11, the worker who executes the external setup changing work executes the external setup changing work using carriage 12 (refer to FIGS. 4, 5A, and 5B) before carriage 12 is moved to component mounting line 5 as the target.

In the example illustrated here, carriage 12 which is scheduled to be exchanged with carriage 12(1) which is illustrated in FIG. 4 is set as carriage 12* which is the work target of the external setup changing work. In the external setup changing work, in addition to spare carriages 12 (carriages 12A, 12B, . . . ) which are stored in external setup area 4, movement and exchanging of tape feeder 21, and installation and exchanging of component reel 16 are carried out for all carriages 12, as a target, which are present on the production floor including carriages 12 which are already installed in component mounters M4 and M5 of component mounting line 5. Component reel 16 which is the work target is picked up from component storage device 7 of storage area 3 and carried into external setup area 4.

When exchanging carrier tape 15, component reel 16 is collated by portable terminal 13 which is provided with code reader 14. Portable terminal 13 is capable of transmitting and receiving data to and from host system 2 in a wireless manner. Code reader 14 includes a camera, a laser scanner, and the like, and scans identification code D which is printed on label L which is attached to component reel 16 to recognize code C which is recorded in identification code D. In other words, code reader 14 is a recognizer which scans identification code D which is attached to component reel 16 and recognizes code C which is recorded in identification code D.

In FIG. 1, component mounting line 5 is provided with board supply device M1, board transfer device M2, solder printing device M3, component mounters M4 and M5, reflow device M6, and board collection device M 7. The respective devices of board supply device M1 to board collection device M7 are connected to host system 2 via network 6.

Carriage 12 after the external setup work in which tape feeder 21 and component reel 16 are set in a disposition state corresponding to the product type in external setup area 4 is transferred to component mounting line 5 and attached to component mounters M4 and M5. In component mounting line 5, the components are mounted onto an unmounted board which is supplied by board supply device M1 using component mounters M4 and M5. Subsequently, the component-mounted board is sent to reflow device M6, and the mounted components are solder-bonded to the board. Then, the mounted board onto which the components are mounted by solder bonding is collected by board collection device M7.

Next, description will be given of the configuration and functions of component mounters M4 and M5 which perform the component mounting work in component mounting line 5 with reference to FIGS. 4, 5A, and 5B. In FIG. 4, board transport mechanism 18 is arranged in the X direction on table 17. Board transport mechanism 18 transports board 19 onto which the components are mounted using a conveyor, and board 19 is positioned at a mounting working position which is provided on board transport mechanism 18.

Carriage installer 20(1) is provided on the front side of board transport mechanism 18, and carriage installer 20(2) is provided behind board transport mechanism 18. Carriages 12(1) and 12(2) which serve as component suppliers, in which a plurality of tape feeders 21 for supplying components are set, in carriage installers 20(1) and 20(2) are detachably installed in component mounters M4 and M5, respectively.

Feeder addresses 20a for specifying the installation positions of tape feeders 21 are set in feeder base 28 (refer to FIGS. 5A and 5B) provided on carriages 12 (1), 12 (2). Tape feeder 21 which is installed in feeder base 28 supplies the components to a component suction position using suction nozzle 24a (refer to FIG. 5B) of mounting head 24 which is described below.

Y-axis moving beam 22 which is provided with a linear drive mechanism is arranged on the end portion of one side on the top surface of table 17 in the X direction, and two X-axis moving beams 23 which are similarly provided with linear drive mechanisms are joined to Y-axis moving beam 22 to move freely in the Y direction. Mounting head 24 is installed on each of two X-axis moving beams 23 to move freely in the X direction. Mounting head 24 is provided with a plurality of holding heads, and suction nozzles 24a which hold the components by suction and are capable of being lifted and lowered are installed at the bottom end portions of the respective holding heads.

Mounting head 24 moves in the X direction and the Y direction due to Y-axis moving beam 22 and X-axis moving beam 23 being driven. Accordingly, using suction nozzles 24a, two mounting heads 24 pick up the components from the component suction positions of tape feeders 21 of carriage installers 20(1) and 20(2) corresponding to each mounting head 24, and transfer and mount the components onto mounting points on board 19 which is positioned in board transport mechanism 18. Y-axis moving beam 22, X-axis moving beams 23, and mounting heads 24 configure component mounting mechanism 25 which picks up the components from carriage installer 20(1) and 20(2) and moves and mounts the components onto board 19 by moving mounting heads 24 which hold the components.

Component recognition cameras 26 are arranged between carriage installers 20(1) and 20(2) and board transport mechanism 18. When mounting heads 24 which pick up the components from carriage installers 20(1) and 20(2) move above component recognition cameras 26, component recognition cameras 26 image and recognize the components in the state of being held by mounting heads 24. Board recognition camera 27 which is positioned on the bottom surface side of X-axis moving beam 23 and which moves integrally with the corresponding mounting head 24 is installed on mounting head 24. Due to the movement of mounting head 24, board recognition camera 27 moves above board 19 which is positioned in board transport mechanism 18, and board recognition camera 27 images and recognizes board 19. In a component mounting operation to board 19 carried out by mounting head 24, mounting position correction is performed, taking into account the recognition results of the component by component recognition camera 26 and the recognition results of the board by board recognition camera 27.

FIG. 5A illustrates carriage installers 20(1) and 20(2) and the device operation surfaces in component mounters M4 and M5. Carriage 12 which is in a state in which a plurality of tape feeders 21 are set in advance on feeder base 28 is installed in carriage installers 20(1) and 20(2). A plurality of component reels 16 which wind and house carrier tapes 15 are held in carriage 12, and carrier tapes 15 hold the components. Carrier tape 15 which is pulled out from component reel 16 is installed in the corresponding tape feeder 21.

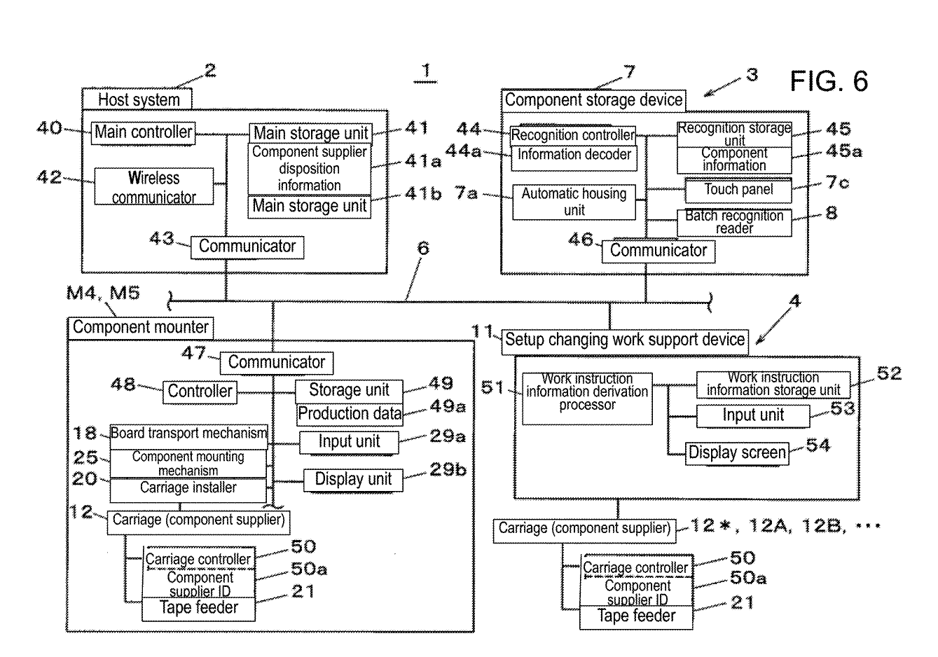

In carriage 12, the positions of carriage installers 20(1) and 20(2) are fixed by clamping feeder base 28 using a clamp mechanism (not illustrated). Additionally, carriage 12 is electrically connected to controller 48 (refer to FIG. 6) of component mounters M4 and M5. Accordingly, it is detected that carriages 12 are installed in component mounters M4 and M5, and it is possible to transfer signals between controller 48 and carriage controller 50 (refer to FIG. 6) which is described below.

Controller 48 is capable of individually identifying each carriage 12 due to the storage unit (not illustrated) of carriage controller 50 storing component supplier ID 50a (refer to FIG. 6) which is previously assigned to each carriage 12, and carriages 12 being installed in component mounters M4 and M5. Accordingly, each carriage 12 is individually identified by the identification function with which component mounters M4 and M5 are provided.

On the device operation surface, operator 29 which is provided with display unit 29b and input unit 29a is provided. Operation buttons for performing various operation inputs are disposed on input unit 29a. Display unit 29b is a display device such as a liquid crystal panel, and various screens such as a guidance screen for performing operational input using input unit 29a are displayed. This screen includes work instruction information which is used in the instruction of setup changing work which accompanies the switching of the product type.

Description will be given of the configuration and functions of tape feeder 21 with reference to FIG. 5B. Tape feeder 21 is configured to include main body 21a and installer 21b which projects downward from the bottom surface of main body 21a. In a state in which tape feeder 21 is installed with the bottom surface of main body 21a aligned with feeder base 28, the connector portion which is provided on installer 21b is fitted to feeder base 28.

Accordingly, tape feeder 21 is installed in a fixed manner to carriage installers 20(1) and 20(2), and tape feeder 21 is electrically connected to controller 48 (refer to FIG. 6) of component mounters M4 and M5. Accordingly, it is detected that tape feeders 21 are installed on feeder bases 28 of component mounters M4 and M5, and it is possible to transfer signals between controller 48 and feeder controller 30 which is described below.

Tape feeding unit 31 which is provided with a tape feed mechanism for pitch feeding carrier tape 15 is embedded in main body 21a. Tape feeding unit 31 is provided with a drive mechanism for rotationally driving a sprocket for feeding the tape which is provided at a tip portion of the tape guideway, and feeder controller 30 for controlling the drive mechanism. Carrier tape 15 which is pulled out from component reel 16 is pitch fed by tape feeding unit 31 to the pickup position by suction nozzle 24a of mounting head 24.

A feeder ID code for identifying and specifying tape feeder 21 from others is stored in a memory device which is embedded in feeder controller 30, and controller 48 is capable of individually identifying each tape feeder 21 due to tape feeders 21 being installed in carriage 12.

The storage unit which is embedded in feeder controller 30 stores number of components N which are housed by carrier tape 15 which is installed in tape feeder 21, and number of components N is counted down each time a component is picked up by suction nozzle 24a. Therefore, number of components N of the components which are housed by component reel 16 is stored in the storage unit of feeder controller 30. The stored number of components N (the number of remaining components) which are housed in component reel 16 is transmitted to host system 2 via controller 48 of component mounters M4 and M5 and network 6 at a predetermined timing such as the exchanging of board 19.

Next, description will be given of the configuration of the control system of component mounting system 1 with reference to FIG. 6. Host system 2 is provided with main controller 40 and main storage unit 41 which function as a management computer, and host system 2 transfers control signals and information with each device which configures component mounting system 1 via wireless communicator 42, communicator 43, and network 6. Main storage unit 41 stores component supplier disposition information 41a and component information 41b.

Component supplier disposition information 41a is information relating to the disposition state of tape feeders 21 in all carriages 12 which are present in the production area, such as carriages 12 which are attached to component mounters M4 and M5 of component mounting line 5 and spare carriages 12 which are disposed in external setup area 4. Component information 41b is information including item name information In, order information Io, serial number Is, number of components N, vendor information Iv, and the like which are recorded on label L which is attached to component reel 16 in addition to the type and location of the component which is housed in component reel 16 (information which specifies tape feeder 21 which is installed, component storage device 7 which is stored, and the like).

Item name information In is an encoded component name. Order information Io is a management number which is assigned by an ordering party who orders the components from the vendor. Serial number Is is a management number which is allocated by the vendor. Number of components N is the number of components (the remaining number of components) which are housed in component reel 16. Vendor information Iv is the maker number. In component mounting system 1, serial number Is in component information 41b is used as a unique management number Im for managing component reel 16. A unique number which is obtained by combining a plurality of items of information such as a combination of serial number Is and item name information In may be used as management number Im.

In FIG. 6, component storage device 7 of storage area 3 is provided with recognition controller 44, recognition storage unit 45, automatic housing unit 7a, touch panel 7c, and batch recognition reader 8, and transfers control signals and information with host system 2 via communicator 46 and network 6. Touch panel 7c is provided with an input function and a display function, performs operations and data input which are necessary during operation, and displays various operation and guidance screens. Recognition controller 44 is an arithmetic processing device and is provided with information decoder 44a which serves as an internal processing function. Recognition storage unit 45 is a memory device and stores component information 45a and the like.

Recognition controller 44 controls batch recognition reader 8 to scan, as a batch, a plurality of identification codes D which are printed on the plurality of labels L which are attached to component reel 16 and recognize codes C which are recorded in identification codes D. Information decoder 44a decodes each item of the information such as item name information In, order information Io, serial number Is, number of components N, and vendor information Iv from the plurality of codes C which are recognized by batch recognition reader 8.

In other words, information decoder 44a decodes at least any one of item name information In, order information Io, serial number Is, number of components N, and vendor information Iv from the recognized code C. Each item of the decoded information is stored in recognition storage unit 45 as component information 45a and is also transmitted to host system 2 and stored in main storage unit 41 as component information 41b. In this manner, recognition storage unit 45 (or main storage unit 41) is a storage unit that stores each item of decoded information.

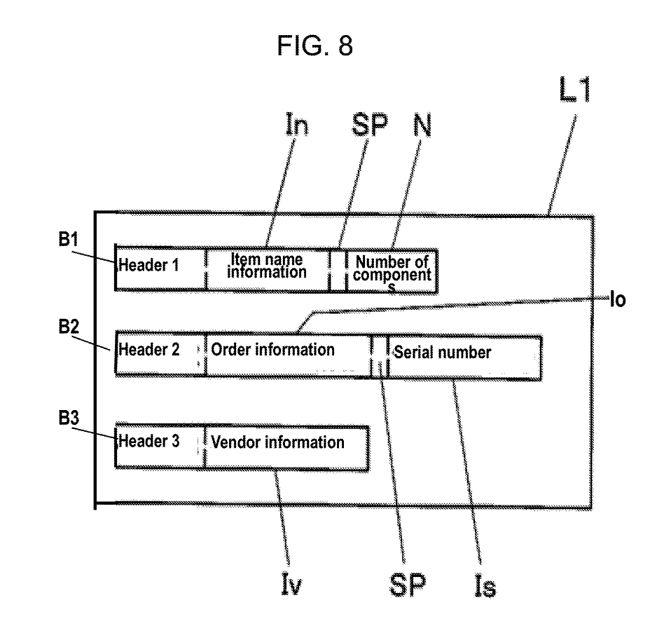

Here, description will be given of examples of identification code D which is printed on label L1, and code C which is recorded in identification code D, with reference to FIG. 8. Bar-codes B1, B2, and B3 are printed on label L1 as identification code D. Code C in which header 1, item name information In, delimiting symbol SP, and number of components N are coded is recorded in bar-code B1. Code C in which header 2, order information Io, delimiting symbol SP, and serial number Is are coded is recorded in bar-code B2. Code C in which header 3 and vendor information Iv are coded is recorded in bar-code B3.

Information decoder 44a decodes each item of information based on predetermined rules from the recognized code C. The predetermined rules are defined based on the type of identification code D such as bar code B and two-dimensional code Q, the number of digits of code C of each item of information, the type of characters which are used in each item of information, the position of delimiter SP, and the like. In other words, information decoder 44a decodes each item of information based on the type of identification code D, the number of digits of code C that is allocated to each item of information, and the type of characters which are used in each item of information.

When each item of information is registered in recognition storage unit 45 (or in main storage unit 41), information identifying identification code D which includes the information is also associated therewith and stored. In other words, in a case in which each item of information is divided into a plurality of identification codes D and recorded on component reel 16, when the information of component reel 16 is registered, each item of information which is decoded from all identification codes D is associated with identification code D thereof and stored in recognition storage unit 45 (or in main storage unit 41). Identification code D need not be printed on one label L, and identification codes D for recording different information may be printed on a plurality of corresponding labels L.

In a case in which information decoder 44a decodes the information which is not stored in recognition storage unit 45 (or in main storage unit 41), information decoder 44a determines that the decoded information is bar-code B5 of label L3 which is attached to component reel 16 later. Number of components N is decoded from code C which is recorded in bar-code B5, and number of components N of component information 45a (or component information 41b) is updated. In other words, when collating the registered component reel 16, in a case in which batch recognition reader 8 (the recognize′) recognizes identification code D (bar-code B5) which is different from identification code D which is stored in recognition storage unit 45 or main storage unit 41 (the storage unit), number of components N is decoded and stored from code C which is recorded in identification code D.

In FIG. 6, component mounters M4 and M5 are connected to network 6 via communicator 47, and are provided with controller 48 and storage unit 49. Controller 48 is an arithmetic processing device and controls board transport mechanism 18, component mounting mechanism 25, and carriage 12 which is installed in carriage installer 20 based on production data 49a which is stored in storage unit 49, that is, based on data such as the mounting data and component supplier disposition information 41a which are downloaded from main storage unit 41 of host system 2 and stored for each product type to be produced. Accordingly, the component mounting work for mounting the components which are picked up from each tape feeder 21 onto board 19 is executed.

Carriage 12 is individually provided with component supplier ID 50a, and each tape feeder 21 which is installed in carriage 12 is individually provided with a feeder ID. Based on component supplier ID 50a and feeder ID, controller 48 identifies carriage 12 which is installed in carriage installer 20 and tape feeder 21 which is installed in carriage 12. Management number Im of component reel 16 for winding and housing carrier tape 15 which is installed in tape feeder 21 which is attached to feeder address 20a of each carriage 12 is identified by comparing the identification results with the data which is defined in production data 49a in advance.

The number of components N of carrier tape 15 which is installed in tape feeder 21 is transmitted to host system 2 and number of components N of the corresponding component reel 16 which is stored in component information 41b is updated based on management number Im. Input unit 29a and display unit 29b are provided on operator 29 of the device operation surface illustrated in FIG. 5A, and respectively perform operations, data input, and the display of various operation and guidance screens which are necessary during operation.

In FIG. 6, setup changing work support device 11 includes various display screens which are referred to in order to efficiently and easily carry out a setup changing work such as exchanging and disposition changing of tape feeders 21, installation of carrier tape 15 in tape feeder 21, and performing notification which are required in carriages 12(1) and 12(2) which are installed in carriage installers 20(1) and 20 (2) in accordance with the switching of product types. The setup changing work is executed in advance in external setup area 4 before carriages 12(1) and 12(2) are carried into component mounting line 5. The setup changing work may be directly executed on carriages 12 which are installed in component mounters M4 and M5.

Setup changing work support device 11 is provided with work instruction information derivation processor 51, work instruction information storage unit 52, input unit 53, and display screen 54. Based on the component supplier disposition information 41a which is stored in main storage unit 41 of host system 2, work instruction information derivation processor 51 derives work instruction information for defining the setup changing work such as removing, attaching, and changing the position of tape feeder 21 in carriage 12* which serves as the work target, and exchanging carrier tape 15 to be installed in tape feeder 21. The work instruction information which is derived is stored in work instruction information storage unit 52 and is displayed on display screen 54. While performing operational input via input unit 53, the worker sequentially executes the setup changing work according to the displayed work instruction information.

Component reel 16 for winding and housing carrier tape 15 which is installed in tape feeder 21 in the setup changing work is picked up from component storage device 7 and carried into external setup area 4 from storage area 3. When installing the loaded carrier tape 15 in the instructed tape feeder 21, identification code D of label L which is attached to component reel 16 is collated using portable terminal 13. Component reel 16 which is removed from tape feeder 21 is conveyed to storage area 3 and stored in component storage device 7.

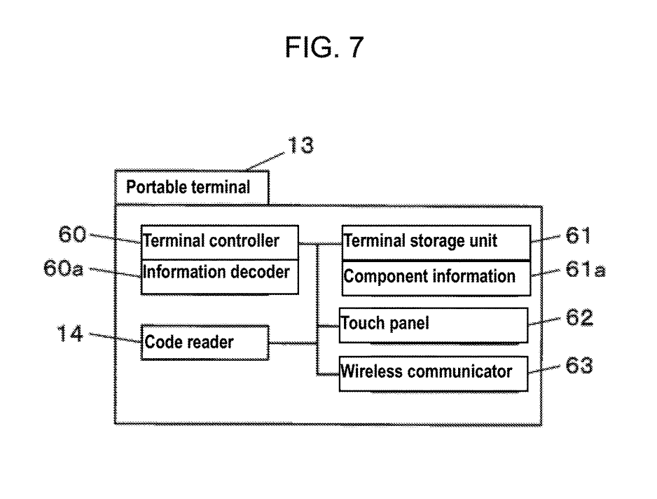

Next, description will be given of the configuration of the control system of portable terminal 13 with reference to FIG. 7. Portable terminal 13 is provided with terminal controller 60, terminal storage unit 61, code reader 14, and touch panel 62, and transfers control signals and information with host system 2 via wireless communicator 63. Touch panel 62 is provided with an input function and a display function, performs operations and data input which are necessary during operation, and displays various operation and guidance screens. Terminal controller 60 is an arithmetic processing device and is provided with information decoder 60a which serves as an internal processing function. Terminal storage unit 61 is a memory device and stores component information 61a and the like.

Terminal controller 60 controls code reader 14 to sequentially scan a plurality of identification codes D which are printed on the plurality of labels L which are attached to component reel 16 and recognize codes C which are recorded in identification codes D. Information decoder 60a decodes each item of information such as item name information In, order information Io, serial number Is, number of components N, and vendor information Iv from the plurality of codes C which are recognized by code reader 14.

In other words, information decoder 60a decodes at least any one of item name information In, order information Io, serial number Is, number of components N, and vendor information Iv from code C which is recognized. Each item of decoded information is stored in terminal storage unit 61 as component information 61a and is also transmitted to host system 2 and stored in main storage unit 41 as component information 41b. In this manner, terminal storage unit 61 is a storage unit that stores each item of the information which is decoded.

In the setup changing work, when installing carrier tape 15 in the instructed tape feeder 21, the worker recognizes identification code D of label L which is attached to component reel 16 and collates whether or not component reel 16 is the specified component reel 16 using portable terminal 13. During the collation, serial number Is, which is management number Im of component reel 16 to be collated, is transmitted to portable terminal 13 from host system 2. Terminal controller 60 continues scanning using code reader 14 until serial number Is is recognized.

In other words, when collating the registered component reel 16, terminal controller 60 performs control such that code reader 14 (recognize′) does not cancel scanning until identification code D, in which serial number Is which is specified among identification codes D which are stored is recorded, is recognized. When serial number Is is recognized, terminal controller 60 collates whether or not serial number Is matches the specified management number Im and causes touch panel 62 to display the result.

As described above, component mounting system 1 of the exemplary embodiment is a management system which manages component information (component information 45a, 61a, and 41b) from identification code D which is attached to component reel 16 which houses electronic components (components) includes a recognizer (batch recognition reader 8 and code reader 14) which scans identification code D which is attached to component reel 16 and recognizes code C which is recorded in identification code D, information decoder (information decoders 44a and 60a) which decodes at least any one of item name information In, order information Io, serial number Is, number of components N, and vendor information Iv from the recognized code C, and a storage unit (recognition storage unit 45, terminal storage unit 61, and main storage unit 41) which stores each item of decoded information.

In the management system, in a case in which each item of information is divided into a plurality of identification codes D and recorded on component reel 16, when the information of component reel 16 is registered, each item of information which is decoded from all identification codes D is associated with identification code D thereof and stored in the storage unit. Accordingly, it is possible to manage component reel 16 by using label L which is attached during the delivery without attaching label L on which identification code D for exclusive management is printed when delivering component reel 16.

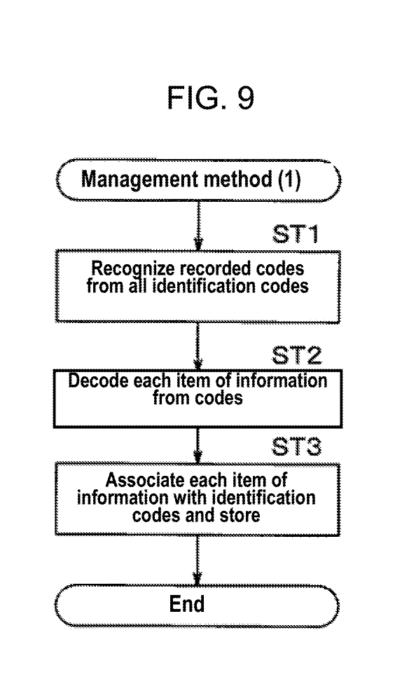

Next, description will be given of a first example of a management method which manages component information from identification code D which is attached to component reel 16 which houses electronic components (components), according to the flow of FIG. 9. The first example of the management method is executed when a new component reel 16 which is delivered from a vendor is delivered to component mounting system 1 (the management system), or the like. Here, description will be given of an example of storing the new component reel 16 which is delivered in component storage device 7.

First, when the worker inserts component reel 16 into component storage device 7 from inlet-outlet 7b, batch recognition reader 8 (the recognize′) of component storage device 7 scans, as a batch, all identification codes D which are printed on label L which is attached to component reel 16 and recognizes code C which is recorded in identification code D (ST1: recognizing step). Next, information decoder 44a decodes at least any one of item name information In, order information Io, serial number Is, number of components N, and vendor information Iv from the recognized code C (ST2: information decoding step). In information decoding step (ST2), information decoder 44a decodes each item of information based on the type of identification code D, the number of digits of code C that is allocated to each item of information, and the type of characters which are used in each item of information.

Next, recognition controller 44 stores each item of information which is decoded in recognition storage unit 45 (the storage unit) (ST3: storing step). In a case in which each item of information is divided into a plurality of identification codes D and recorded on component reel 16, when the information of component reel 16 is registered, in the storing step (ST3), each item of information which is decoded from all identification codes D is associated with identification code D thereof and stored.

Each item of decoded information is transmitted to host system 2, stored in main storage unit 41 (the storage unit), and used in the management of component reel 16 in component mounting system 1 (the management system). Accordingly, it is possible to manage component reel 16 by using label L which is attached during the delivery without attaching label L on which identification code D for exclusive management is printed when delivering component reel 16.

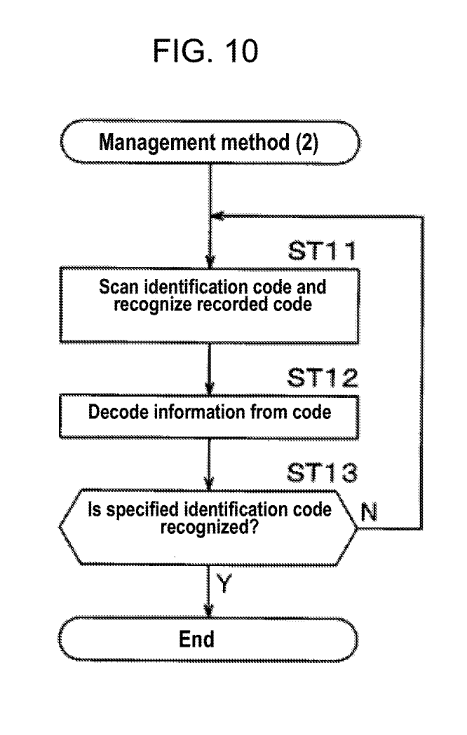

Next, description will be given of a second example of a management method which manages component information from identification code D which is attached to component reel 16 which houses electronic components (components), according to the flow of FIG. 10. The second example of the management method is executed by performing collation or the like when carrier tape 15 which is wound and housed in component reel 16 which is stored in component mounting system 1 (the management system) is installed in tape feeder 21. Here, description will be given of an example in which carrier tape 15 is collated using portable terminal 13 before being installed in tape feeder 21.

First, the operator scans one identification code D which is printed on label L which is attached to component reel 16 using code reader 14 (the recognizer) of portable terminal 13, and code C which is recorded in identification code D is recognized (ST11: recognizing step). Next, information decoder 44a decodes the information which is recorded from code C which is recognized (ST12: information decoding step). Next, recognition controller 44 determines whether or not the decoded information includes management number Im, that is, whether or not code reader 14 recognizes the specified identification code D including management number Im (ST13).

In a case in which the specified identification code D is not recognized (No in ST13), code reader 14 holds the scan state, returns to the recognizing step (ST11), and scans the next identification code D. In a case in which the specified identification code D is recognized (Yes in ST13), code reader 14 cancels the scan state. In other words, when collating the registered component reel 16, in recognizing step (ST11), recognition controller 44 does not cancel scanning until identification code D, which is specified among identification codes D which are stored, is recognized. Accordingly, even if the operator does not know the position of label L on which the specified identification code D as management number Im is printed, the operator is capable of executing the collation of component reel 16 by sequentially scanning identification codes D using portable terminal 13.

In a case in which the recognition step (ST11) is performed for a first predetermined number of times (for example, three times) in the determination (ST13) of whether or not the specified identification code D is recognized, it may be determined as to whether or not the specified identification code D that is configured is stored in the plurality of recognized codes C.

At this time, in a case in which the specified identification code D which is formed of the plurality of recognized codes C is stored, it is determined that the specified identification code D is not yet recognized, and code reader 14 holds the scan state, the process returns to the recognizing step (ST11), and the next identification code D is scanned. In a case in which the specified identification code D which is formed of the plurality of recognized codes C is not stored, it is determined that an abnormality such as code C being replaced or another component reel 16 being read occurs, the scan is interrupted, and the worker is notified of the abnormality.

In a case in which the recognizing step (ST11) is performed greater or equal to a second predetermined number of times exceeds (for example, 10 times) which exceeds the first predetermined number of times, if it is determined that an abnormality such as an inability to recognize the specified identification code D or the specified identification code D being peeled off arises, the scan may be canceled and the worker may be notified of the abnormality.

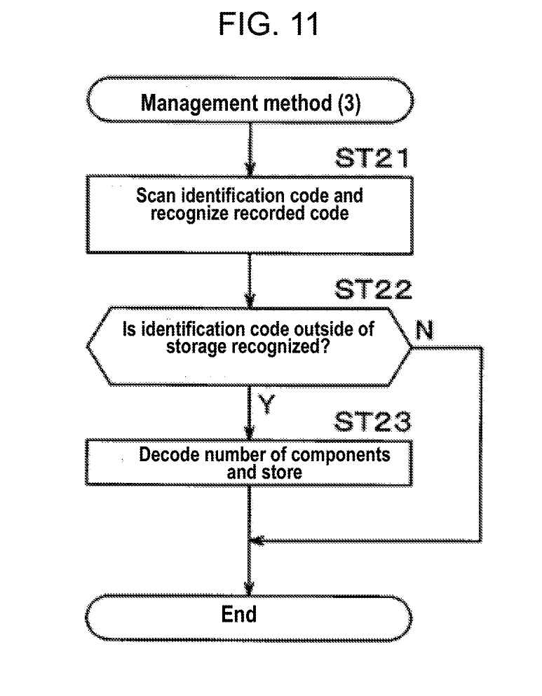

Next, description will be given of a third example of a management method which manages component information from identification code D which is attached to component reel 16 which houses electronic components (components), according to the flow of FIG. 11 with reference to FIG. 2. The third example of the management method is executed in the collation when component reel 16, which is removed from tape feeder 21 in the setup changing work, is returned to storage area 3 to be stored. Unused components are housed in component reel 16 which is used in the component mounting. Number of components N which are unused in component reel 16 is transmitted from tape feeder 21 to host system 2 at a predetermined timing during the component mounting work.

However, due to the consumption of components that tape feeder 21 may not recognize, such as losses during the supplying of components, number of components N which is stored in host system 2 may contain an error. Therefore, the unused components of component reel 16 which is returned in storage area 3 is weighed using remaining number measuring device 9, and number of components N which is stored is corrected to an accurate value. Number of components N which are weighed is printed on label L3 as bar-code B5 by label printer 10 (refer to FIG. 2). The worker attaches label L3 to the margin of component reel 16. Here, description will be given of an example in which component reel 16 which is removed from tape feeder 21 in the setup changing work is returned to storage area 3 and is collated before being stored in component storage device 7.

First, when the worker inserts component reel 16 into component storage device 7 from inlet-outlet 7b, batch recognition reader 8 (the recognize′) of component storage device 7 scans, as a batch, all identification codes D (bar-codes B1 to B5 and two-dimensional code Q1) which are printed on the plurality of labels L1, L2, and L3 which are attached to component reel 16 and recognizes code C which is recorded in identification code D (ST21: recognizing step) (refer to FIG. 2). Next, information decoder 44a decodes each item of information which is recorded in recognized code C. Recognition controller 44 collates each item of decoded information with the stored component information 45a, and determines whether or not the recognized identification code D includes identification code D that is not stored in recognition storage unit 45 (or main storage unit 41) (ST22).

In a case in which identification code D which is outside of the memory is recognized (Yes in ST22), that is, in a case in which bar-code B5 is recognized, information decoder 44a decodes number of components N from code C of the recognized bar-code B5, and updates and stores number of components N of component information 45a (ST23). In other words, when collating the registered component reel 16, in the recognizing step (ST21), in a case in which identification code D (bar-code B5) which is different from identification code D which is stored is recognized, number of components N is decoded and stored from code C which is recorded in identification code D.

Number of components N is transmitted to host system 2, and number of components N of component information 41b which is stored in main storage unit 41 is also updated to an accurate value. Accordingly, it is possible to update number of components N to an accurate value during the storage work of component reel 16. Next, component reel 16 is housed in automatic housing unit 7a of component storage device 7. In a case in which identification code D outside of the memory is not recognized (No in ST22), component reel 16 is housed in automatic housing unit 7a without updating number of components N.

As described above, in the management method of the present embodiment, in a case in which each item of information is divided into a plurality of identification codes D and attached to component reel 16, when the information of component reel 16 is recorded, in the storing step, each item of information which is decoded from all identification codes D is associated with identification code D thereof and stored. Accordingly, it is possible to manage component reel 16 by using label L which is attached during the delivery without attaching label L on which identification code D for exclusive management is printed when delivering component reel 16.

The storage of component reel 16 in storage area 3 is not limited to storage carried out by component storage device 7 which is provided with batch recognition reader 8 and automatic housing unit 7a. For example, identification code D of component reel 16 may be recognized by portable terminal 13 instead of batch recognition reader 8, and the worker may stock (carry in), store, and ship (carry out) component reel 16 in relation to a storage warehouse having a plurality of shelves instead of automatic housing unit 7a.

A management system and a management method of the invention include the effect of being capable of managing a component reel in a delivered state, and are applicable in the field of component mounting in which electronic components are mounted onto a board.

What is claimed is:

1. A management system which manages component information from identification codes which are attached to a component reel which houses electronic components, comprising:
a recognizer which scans each of the identification codes which is attached to the component reel and recognizes a code which is recorded in each of the identification codes;
an information decoder that decodes at least any one of information of item name information, order information, serial number, number of components, and vendor information from the code which is recognized; and
a storage unit which stores each of the information which is decoded,
wherein in a case in which each of the information is divided into the identification codes and recorded on the component reel, when the information of the component reel is stored, each of the information which is decoded from all of the identification codes is associated with the identification codes and stored in the storage unit.

2. The management system of claim 1,
wherein the information decoder decodes each of the information based on a type of each of the identification codes, a number of digits of the code that is allocated to each of the information, and a type of characters which are used in each of the information.

3. The management system of claim 1,
wherein when collating the stored component reel, the recognizer does not cancel scanning until a specified identification code among the identification codes which are stored is recognized.

4. The management system of claim 1,
wherein when collating the registered component reel, in a case in which the recognizer recognizes an identification code which is different from the identification codes which are stored in the storage unit, number of components is decoded from a code which is recorded in the identification code, and stored.

5. A management method which manages component information from identification codes which are attached to a component reel which houses electronic components, the method comprising:
a recognition step of scanning each of the identification codes which is attached to the component reel and recognizing a code which is recorded in each of the identification codes;
an information decoding step of decoding at least any one of information of item name information, order information, serial number, number of components, and vendor information from the code which is recognized; and
a storing step of storing each of the information which is decoded,
wherein in a case in which each of the information is divided into the plurality of identification codes and recorded on the component reel, and when the information of the component reel is stored, each of the information which is decoded from all of the identification codes is associated with the identification codes and stored in the storing step.

6. The management method of claim 5,
wherein in the information decoding step, each of the information is decoded based on a type of each of the identification codes, a number of digits of the code that is allocated to each of the information, and a type of characters which are used in each of the information.

7. The management method of claim 5,
wherein when collating the stored component reel, in the recognition step, the scanning is not canceled until a specified identification code among the identification codes which are stored is recognized.

8. The management method of claim 5,
wherein when collating the stored component reel, in the recognition step, in a case in which an identification code which is different from the identification codes which are stored is recognized, a number of components is decoded from a code which is recorded in the identification code, and stored.
